(19) United States
(12) Patent Application Publication
(10) Pub. No.: US 2025/0328901 A1
(43) Pub. Date: Oct. 23, 2025

(54) CONDITION-BASED DATA TRANSACTIONS

(71) Applicant: Motorola Mobility LLC, Chicago, IL (US)

(72) Inventors: Krishnan Raghavan, Bangalore (IN); Nakul Patel, Bangalore (IN); Vinay Basavanna, Bangalore (IN)

(73) Assignee: Motorola Mobility LLC, Chicago, IL (US)

(21) Appl. No.: 18/639,527

(22) Filed: Apr. 18, 2024

(51) Int. Cl. G06Q 20/40

(52) U.S. Cl. CPC G06Q 20/401

(57) ABSTRACT

In aspects of condition-based data transactions, a client device can receive a request to execute a data transaction. The client device can detect a condition corresponding to a failure to execute the data transaction at a first time. For example, the condition corresponding to the failure to execute the data transaction at the first time can include at least one of a network connection status, one or more characteristics of a network connection, a server status, a stored balance associated with the payment service, or a threshold numerical quantity of data transactions associated with the payment service for a duration of a timer, a threshold numerical quantity of data transactions for a geographic location, or a threshold transaction value for the geographic location. The client device can execute the data transaction at a later based on a change in the condition corresponding to the failure to execute the data transaction.

### BACKGROUND

Devices, such as smart devices, mobile devices (e.g., cellular phones, tablet devices, smartphones), consumer electronics, and the like, can be implemented for use in a wide range of environments and for a variety of different applications. A mobile device can include or implement one or more applications. For example, the applications include wallet functionality for transferring balances to execute a payment (e.g., for material goods, food, housing, services, media content, etc.). A user of the mobile device may provide input, such as via a user interface displaying an instance of the application. The mobile device can execute a data transaction in response to the user input. In some examples, the data transaction includes exchange of data related to a payment made via the purchase application. The data can include, but is not limited to, a value (e.g., cost) of the payment and a merchant or other category of the payment. The mobile device can deduct the value from a stored balance for the user via a payment service.

### BRIEF DESCRIPTION OF THE DRAWINGS

Implementations of the techniques for condition-based data transactions are described with reference to the following Figures. The same numbers may be used throughout to reference like features and components shown in the Figures:

FIGS. 1 and 2 illustrate example systems for condition-based data transactions in accordance with one or more implementations as described herein.

FIGS. 3 and 4 illustrate example user interfaces for condition-based data transactions in accordance with one or more implementations as described herein.

FIG. 5 further illustrates an example flowchart for condition-based data transactions in accordance with one or more implementations as described herein.

FIG. 6 illustrates an example method for condition-based data transactions in accordance with one or more implementations of the techniques described herein.

FIG. 7 illustrates various components of an example device that can be used to implement the techniques for condition-based data transactions as described herein.

### DETAILED DESCRIPTION

Implementations of techniques for condition-based data transactions are described herein. In some examples, a device (e.g., a mobile device or a client device) can implement one or more applications or services. For example, the device implements one or more applications that interface with or include a payment service for executing a data transaction, where the data transaction can include a payment or transfer of a value to and from a stored balance of a user account of the application, a request to update one or more user account settings, and a request to obtain documentation, among others. In some variations, the application receives user input via a user interface of the device that triggers or initiates execution of the data transaction related to a user account. The device executes the data transaction by indicating the payment service to deduct a value from a stored balance from the user account when the data transaction is a payment or transfer that indicates the value.

In some examples, there is a time period during which the data transaction is to be executed (e.g., in real-time and/or according to a scheduled time period), such as prior to a deadline for the data transaction. For example, the data transaction can include a payment for a service provided to the user of the device, where the service is terminated if the data transaction is not executed during the time period. Additionally, or alternatively, the data transaction can include a scheduled payment and/or a payment in real-time for one or more items. In some variations, the items are to be consumed or used by the user of the device during the time period (e.g., food for a meal during the time period, an item used to complete a task during the time period, etc.). In some other variations, the data transaction can include a retroactive and/or proactive payment for one or more items consumed during the time period and/or outside of the time period. For example, the data transaction can include a payment from a business to another business, such as a payment to an office stationery supplier from a business.

However, the device may be unable to execute the data transaction when prompted to execute the data transaction (e.g., via a user input provided by the user). For example, one or more conditions may not be satisfied for execution of the data transaction when the device receives user input initiating execution of the data transaction. The conditions can include, but are not limited to, characteristics of a network connection, availability of a server for the payment service, a stored balance for an account of a user that is being used for the payment, a threshold numerical quantity of data transactions over a time period for the account of the user, a threshold numerical quantity of data transactions for a current location of the user, a threshold value of data transactions for a current geographic location of the user, a threshold numerical quantity of data transactions for a defined geographic location within a threshold time period, and/or a threshold time period (e.g., duration) during which the data transaction can be executed, among other examples. If the condition is not satisfied (e.g., a network connection is unstable or weak, a network connection is not established, a stored balance of the account fails to satisfy a threshold value, the threshold numerical quantity of data transactions over the time period for the account is exceeded, a threshold numerical quantity of data transactions for a current location of the user is exceeded, a threshold value of data transactions for the current location is exceeded, a numerical quantity of data transactions for a geographic location within a threshold time period is exceeded, a threshold time period for executing the data transaction expires, etc.), then the data transaction may not execute or may fail to execute. The user may manually continue to provide user input to the device initiating execution of the data transaction if the data transaction fails. Upon which, the device can reattempt to execute the data transaction, which may continue to fail to execute further, causing increased processing and memory resource usage at the device, as well as increased power consumption at the device.

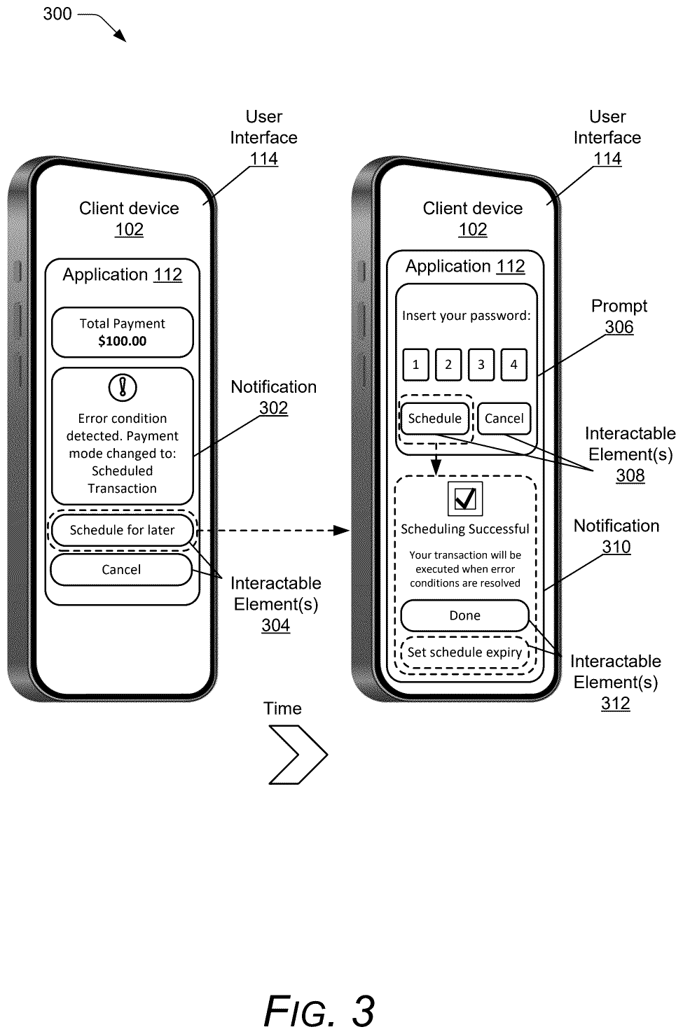

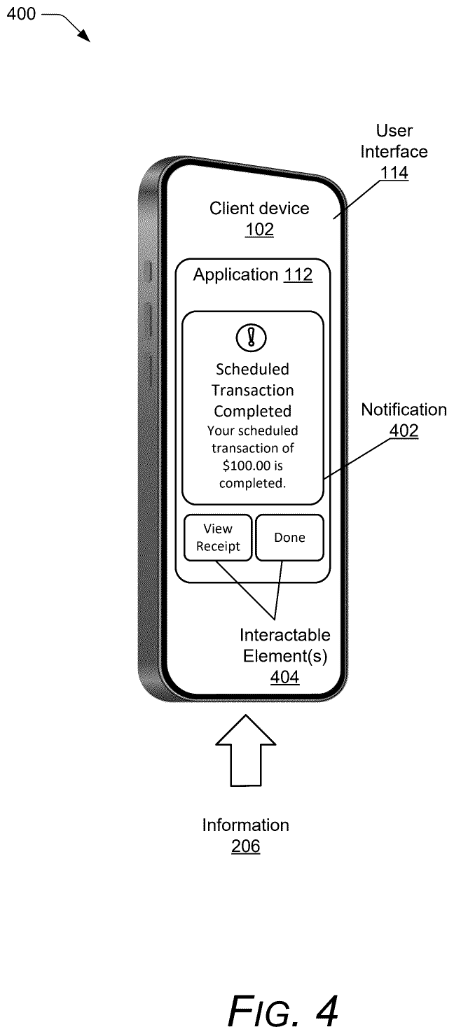

As described herein, to reduce usage of processing and memory resources and to reduce power consumption at a device related to reattempts to execute a data transaction when conditions are not satisfied, a device can schedule the data transaction to execute when the device detects one or more conditions for execution of the data transaction are satisfied. In some variations, the device receives a request to execute a data transaction. The device can monitor for one or more conditions related to an error in execution of the data transaction, such as conditions related to a network connection, a stored balance of the account, a threshold numerical quantity of data transactions over a time period for the account, a threshold numerical quantity of data transactions for a current location of the user, and/or a threshold value of data transactions for the current location among other conditions. If the device detects a condition that causes an error in execution of the data transaction, then the device can determine to schedule the data transaction at a later time, such as once the condition that causes the error is resolved (e.g., a network connection is established, a strength of a network connection increases to satisfy a threshold strength, a stored balance of the account is increased to satisfy a threshold value, or a numerical quantity of data transactions is reset upon expiry of a time period). In some examples, the device can display one or more interactable elements via a user interface of the device, and a user provides user input indicating for the device to schedule the data transaction, which is described in further detail with respect to FIGS. 3 and 4. In some other examples, the device can automatically schedule the data transaction upon detecting the condition (e.g., without user input indicating for the device to schedule the data transaction). If the data transaction is scheduled, once the conditions for execution of the data transaction are satisfied or resolved, then the device can execute the data transaction.

In some examples, a device scheduling a data transaction based on a condition being met or satisfied may provide for reduced use of computational resources (e.g., processing resources, memory resources, communication resources etc.). For example, conventionally, a device continuously or periodically attempts to execute a data transaction even if a previous data transaction fails, causing increased usage of computational resources to process and execute the data transaction. Additionally, or alternatively, the device may not continuously or periodically attempt to execute the data transaction if an initial attempt to execute the data transaction fails, and may instead rely on a user of the device to provide user input to execute the data transaction, causing increased usage of computational resources due to displaying one or more conditions for executing the data transaction (e.g., a network status, an account balance, etc.) to a user and receiving additional user input indicating for the device to execute the data transaction. A user providing user input to execute the data transaction is also inconvenient for the user. As described herein, a device detects a condition for executing the data transaction is not met prior to attempting to execute the data transaction, and the device can display a notification via a user interface of the device indicating that the condition is not met. In some examples, the device can request for the user to provide user input that approves the device to schedule the data transaction to execute automatically (e.g., without user input initiating execution of the data transaction) when the condition is met. In some other examples, the device can schedule (e.g., without requesting the approval via the user input) the data transaction to execute automatically when the condition is met.

While features and concepts of the described techniques for condition-based data transactions can be implemented in any number of different devices, systems, environments, and/or configurations, implementations of the techniques for condition-based data transactions are described in the context of the following example devices, user interfaces, systems, and methods.

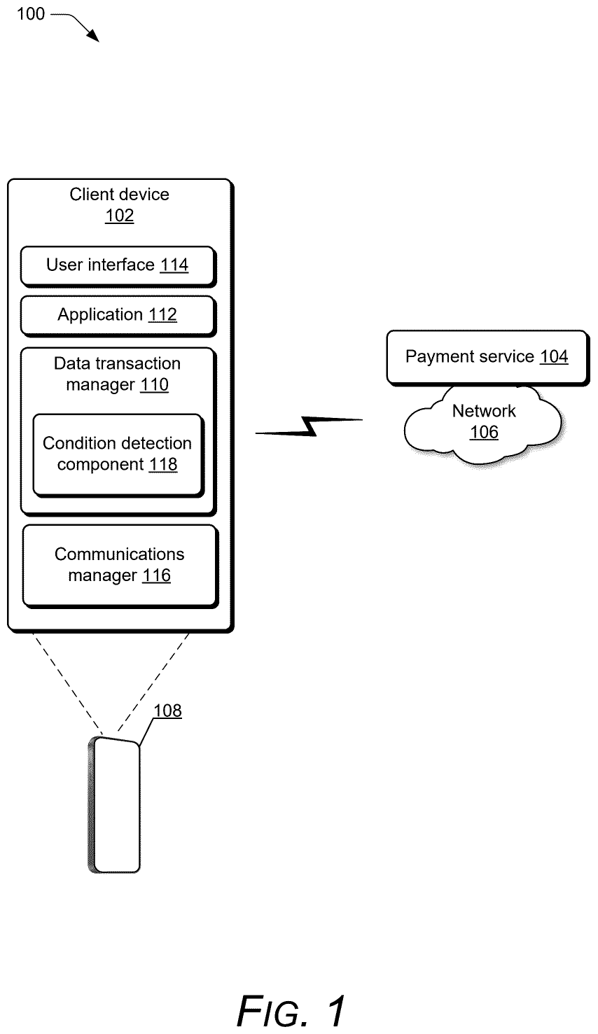

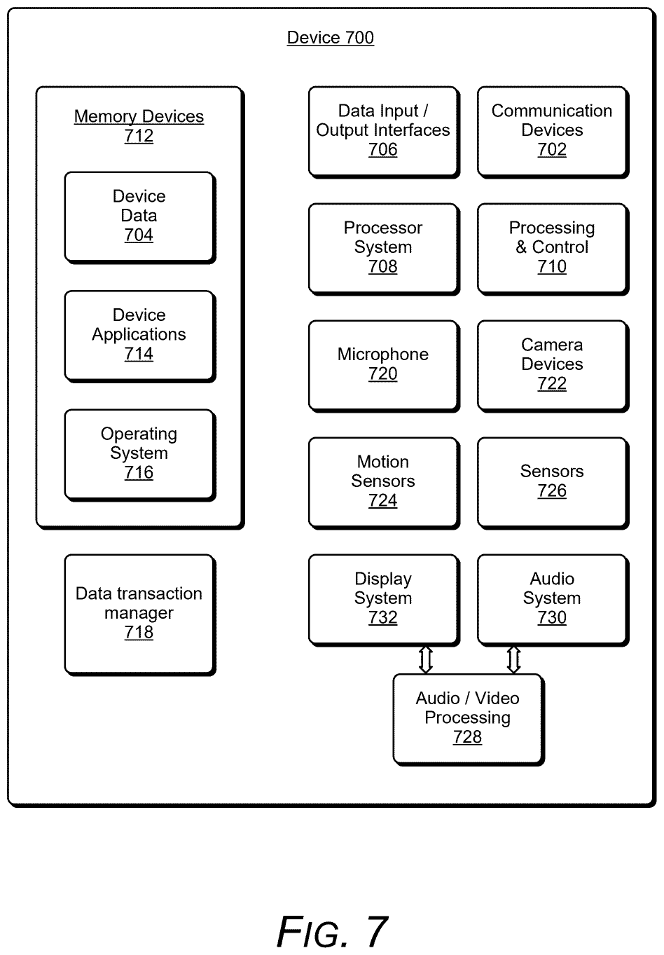

FIG. 1 illustrates an example system 100 for condition-based data transactions, as described herein. The example system 100 includes a client device 102 and a payment service 104, where the client device 102 and the payment service 104 are interconnectable via one or more networks 106. In some examples, the client device 102 includes a server device, a smartphone, a mobile phone, and/or any other type of wireless device or mobile device 108. The client device 102 can be implemented with various components, such as a processor system and memory, as well as any number and combination of different components as further described with reference to the example device shown in FIG. 7. In one or more implementations, the client device 102 includes various radios for wireless communication with other devices (e.g., via the networks 106). For example, the client device 102 may include a Bluetooth (BT) and/or Bluetooth Low Energy (BLE) transceiver and/or a near field communication (NFC) transceiver. The client device 102 can also include a Wi-Fi radio, a global positioning system (GPS) radio, and/or any type of device communication interfaces.

A client device 102 may be configurable in a variety of ways. A client device 102, for instance, is configurable as a desktop computer, a laptop computer, a mobile device 108 (e.g., assuming a handheld configuration such as a tablet or mobile phone), an IoT device, a wearable device (e.g., a smart watch, a ring, or smart glasses), an augmented reality and/or virtual reality device (e.g., the smart glasses), a server, and so forth. Thus, a client device 102 ranges from a full resource device with substantial memory and processor resources to a low-resource device with limited memory and/or processing resources. Although in instances in the following discussion reference is made to a client device 102 in the singular, a client device 102 may also be representative of multiple different devices. The client device 102 may include one or more features in addition to, or as an alternative to, the features illustrated in the system 100.

In some examples, a client device 102 implements a data transaction manager 110 to manage execution of one or more data transactions via an application 112. In one or more implementations, the data transaction manager 110 includes independent processing, memory, and/or logic components functioning as a computing and/or electronic device integrated with the client device 102. Alternatively, or in addition, the data transaction manager 110 can be implemented in software, in hardware, or as a combination of software and hardware components. In one or more examples, the data transaction manager 110 is implemented as a software application or module, such as executable software instructions (e.g., computer-executable instructions) that are executable with a processor system of the client device 102 to implement the techniques and features described herein. As a software application or module, the data transaction manager 110 is stored on computer-readable storage memory (e.g., memory of a device), or in any other suitable memory device or electronic data storage implemented with the module. Alternatively, or in addition, the data transaction manager 110 is implemented in firmware and/or at least partially in computer hardware. For example, at least part of the data transaction manager 110 is executable by a computer processor, and/or at least part of the data transaction manager 110 is implemented in logic circuitry.

In some cases, at least a portion of the data transaction manager 110 is implemented by an application 112 of the client device 102. Additionally, or alternatively, at least a portion of the data transaction manager 110 is implemented using various resources of the client device 102, such as hardware resources, an operating system, firmware, and so forth. Alternatively, or additionally, the data transaction manager 110 is implemented by server-based storage resources, processing resources, and so on of devices other than the client device 102. For example, at least a portion of the data transaction manager 110 can be implemented using a third-party service, such as a web services platform that provides one or more hardware and/or other computing resources to support provision of services by web service providers. In some variations, an entirety, or various portions of the data transaction manager 110 are implemented at or by the client device 102 of a user (e.g., a mobile device 108, a laptop, a wearable device, or any other device). In the example system 100, the client device 102 is a mobile device 108 that incorporates data execution functionality.

The data transaction manager 110 supports execution of a data transaction by receiving user input via the application 112 that initiates execution of the data transaction. The application 112 causes various systems of the client device 102 to output a user interface 114 of the application 112, such as by displaying a user interface 114 via a display device (e.g., a graphical user interface (GUI)) or making accessible voice-based user interfaces. Through interaction of a user with the client device 102, the application 112 receives user input via one or more user interfaces 114. Examples of such input include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. For example, the client device 102 can receive user input that triggers execution of the data transaction. The user input can include input received via a screen of the client device 102, such as via one or more interactable features of the user interface 114 of the client device 102. One example of the application 112 is a browser, which is operable to navigate to a website, display pages of the website, and facilitate user interaction with web pages of the website. Another example of the application 112 is a web-based computer application, such as a mobile application or a desktop application. The application 112 may be configured in different ways, which enable users to interact with the client device 102 and by extension perform actions, without departing from the spirit or scope of the techniques described herein.

In at least one implementation, the application 112 supports communication of data across the network(s) 106 between the client device 102 and the payment service 104. In some variations, the application 112 may be a purchase application or a payment application (e.g., financial applications, payment applications, shopping applications, subscription applications, etc.). Examples of purchase applications include, but are not limited to, an application 112 that implements or communicates with a payment service 104 to provide for purchase of one or more goods, services, or media, among other physical and/or virtual items. Examples of payment application include, but are not limited to, an application that implements or communicates with a payment service 104 to provide for payment to another device or service. To purchase an item or make a payment via the application 112, a user may provide user input indicating for the application 112 to execute a data transaction.

In some examples, the data transaction includes signaling from the client device 102 implementing the application 112 to the payment service 104 to verify a stored balance for a user account satisfies a threshold value (e.g., a value of the item or payment). Once the stored balance is verified, the payment service 104 may deduct a value for the data transaction from the stored balance indicated by the signaling. For example, the signaling may indicate a value that includes the purchase price of the item or a value of a payment, and the payment service 104 may deduct the value from the stored balance. Additionally, or alternatively, the data transaction can include, but is not limited to, a data transaction with a threshold volume of data entry, such as a submission of an application or request for a product (e.g., a fixed deposit), submission of a request for taxation documents, and submission of a request for additional payment instruments (e.g., credit cards and/or debit cards) for a user account. Additionally, or alternatively, the data transaction can include, but is not limited to, a data transaction with a deadline, such as an update to one or more account settings for the user account (e.g., an autopay setting, a user profile, a list of authorized users, a list of approved payees, among other settings), and an update to a transaction threshold value. Additionally, or alternatively, the data transaction can include, but is not limited to, an online deposit of a check or other payment to a stored balance of a user account, canceling a scheduled payment from the stored balance of the user account, scheduling a payment from the stored balance of the user account, and initiating a payment in real-time from the stored balance of the user account (e.g., a credit card bill payment, a utility bill payment, or another bill payment).

In some variations, the application 112 may implement the payment service 104. For example, the payment service 104 may be integrated with the application 112, such that the application 112 maintains stored balances for respective user accounts of the application 112. A user may provide user input, such as one or more account credentials (e.g., username, password) when initializing an application 112 at the client device 102. The application 112 may store one or more respective balances for different user accounts at a database. The database may be a local database at the client device 102 or may be a remote database or server for the payment service 104.

In some other variations, the application 112 interfaces with the payment service 104 by communicating via the networks 106. For example, the application 112 may transmit signaling to the payment service 104 to request a value of the stored balance, to indicate data transaction information, to indicate a user account for an instance of the application 112 that is executing the data transaction, or the like. The payment service 104 may implement, or may be implemented by, a separate application from the application 112 (e.g., a banking application or other financial application). In some examples, the payment service 104 may include one or more payment instruments, such as credit cards, debit cards, banking accounts, and cash applications, among other payment instruments, for accessing a stored balance. In some cases, a user may provide information related to a payments instrument (e.g., a debit card number, a credit card number, credentials linking a banking account, credentials linking a cash application, etc.) to the application 112.

The client device 102 can include a communications manager 116 for transmitting and/or receiving signaling. The communications manager 116 represents functionality (e.g., logic and hardware) for enabling the client device 102 to interconnect with other devices and/or networks, such as the networks 106. The communications manager 116, for instance, enables wireless and/or wired connectivity of client device 102. For example, the communications manager 116 represents one or more antennas for transmitting and receiving signaling from other devices and/or the payment service 104 via the networks 106. The networks 106 can include computer networks and/or telecommunication networks. For example, the networks 106 include a wireless local area network (WLAN), a wireless network, a BT network, a cellular network, a satellite network, and/or a fiber optic network. The networks 106 connect one or more devices, such as the client device 102 and the payment service 104, among others.

In some examples, the data transaction manager 110 may implement a condition detection component 118 with one or more functionalities related to determining whether a data transaction can be executed. The data transaction manager 110 and/or the condition detection component 118 can be implemented as multiple instructions stored on computer-readable storage media and that can be executed by a processor system of the mobile device 108. Additionally, or alternatively, the data transaction manager 110 and/or the condition detection component 118 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). In some other variations, the condition detection component 118 can be implemented at least in part by server-based storage resources, processing resources, and so on, of devices other than the client device 102.

In some examples, the application 112 is an example of a digital banking application that provides for a user to access an account via the client device 102. The digital banking application communicates with a payment service 104 via the network 106 to execute data transactions for respective user accounts. For example, the payment service 104 and/or the application 112 can maintain user accounts for one or more users, where respective user accounts have one or more stored balances that can be credited to or withdrawn from by execution of data transactions. For example, the digital baking application provides for continuous access to the stored balances by a user (e.g., 24 hours a day, seven days a week), provides for execution of data transactions that transfer values to and from a stored balance in real-time or near real-time, and provides for withdrawal of a stored balance by a user via the client device 102. The application 112 can include information for accessing one or more payment instruments (e.g., a credit card number, a debit card number, banking account information, etc.) linked to a user account. The application 112 can implement functionality to execute a data transaction that transfers a stored balance between user accounts (e.g., via the payment instruments) and/or to a merchant account.

In some variations, the client device 102 executes the data transaction by transmitting and receiving signaling to and from the payment service 104. In some cases, the data transaction may have a deadline or may be executed during a time period. For example, the data transaction can be a rent payment for a user. The client device 102 establishes a network connection with the payment service 104 via the network 106 prior to executing the data transaction. If the client device 102 fails to establish a network connection and/or if a strength of the network connection fails to satisfy (e.g., is less than) a threshold value for transmitting and receiving signaling for the data transaction, then the client device 102 may fail to execute the data transaction. However, a user of the client device 102 may initiate execution of a data transaction (e.g., by providing user input initiating execution of the data transaction) when the network connection is less than the threshold value and/or when no network connection is established. For example, the user may provide input to the client device 102 that initiates execution of the data transaction while traveling on a flight or while vacationing in a remote area without a network connection. The lack of network connection and/or the strength of the network connection failing to satisfy the threshold value can cause execution of the data transaction to fail.

In some examples, even if an internet connection is established and has a strength that satisfies the threshold value, one or more other conditions preventing execution of the data transaction can occur, such as server maintenance or slow network speeds. A user of the client device 102 may continue to provide input initiating the data transaction, and the client device 102 attempts to execute the data transaction in response, which causes increased power consumption at the client device 102, increased signaling overhead due to attempts to transmit or receive signaling related to the data transaction, as well as increased use of processing resources to detect initiation of the data transaction and execute the data transaction. Additionally, or alternatively, a user of the device may wait a time period after a data transaction fails prior to providing additional user input to execute the data transaction, causing increased usage of computational resources due to displaying one or more conditions for executing the data transaction (e.g., a network status, an account balance, etc.) to a user and receiving additional user input indicating for the device to execute the data transaction. A network status can include whether a value indicating whether a network connection is established or not. The user waiting for a time period after a data transaction fails may cause the client device 102 to fail to execute the data transaction prior to a deadline and/or time period during which the data transaction is to be executed, causing additional signaling overhead related to delays in a payment.

For example, a user of the client device 102 may provide input that triggers or initiates execution of a data transaction. The client device 102 can display a user interface 114 of an application 112 that includes one or more interactable elements, such as buttons, drop-down menus, and/or text fields. The user can interact with the interactable elements by selecting a button (e.g., clicking on the button), selecting an option from a drop-down menu, and/or providing a text value to a text field. The interactable elements can include one or more options selectable by the user to initiate a data transaction, which can include a transfer of a value from a stored balance for a user account of the user. For example, the user may select an option to initiate a transfer of a value to a merchant account and/or to another user account (e.g., to pay for a material good, housing, service, media content, etc., in real-time and or for a scheduled data transaction). The application 112 can receive an indication from the payment service 104 that a payment is due to a user account (e.g., to a merchant account or another user account) during a time period and can display the indication to the user via the user interface 114. In variations, the data transaction can include a payment in real-time, such as a payment for a good or service that is initiated in real-time or near-real-time when user input is received that initiates execution of the data transaction. In some other variations, the data transaction can include a scheduled payment (e.g., in non-real-time) for a good or service that is scheduled prior to execution of the data transaction (e.g., a payment for rent, utilities, insurance, business-to-business (B2B) transactions to pay for goods, etc.).

In some variations, the data transaction manager 110 can determine that one or more conditions for execution of the data transaction are not satisfied upon reception of the input that initiates execution of the data transaction. Example conditions include, but are not limited to, whether a network connection is established, a strength of the network connection or other characteristics of a network connection, whether a server for the payment service 104 is available, a value of a stored balance for a user account initiating execution of the data transaction, a threshold numerical quantity of data transactions over a time period for the account of the user, a threshold numerical quantity of data transactions for a current location of the user and/or the user device, or a threshold value of data transactions for the current location of the user and/or the user device, among other examples. The characteristics of a network connection can include a speed of the network connection, a type of the network connection (e.g., an internet connection, a cellular connection, a wired connection, or a wireless connection), a strength of the network connection, among other characteristics.

In some cases, an account can have a defined numerical quantity of data transactions that can be executed during a time period (e.g., periodically), where the numerical quantity of data transactions resets at the end of the time period. For example, the account can have a defined numerical quantity of data transactions set to 5 data transactions for a time period of one day, or 24 hours. Every 24 hours, the numerical quantity of data transactions that can be executed can reset to 5. Additionally, or alternatively, an account can have a defined threshold time period and/or duration for executing the data transaction. If the data transaction does not execute within the threshold time period, then the data transaction has failed.

Additionally, or alternatively, the account can have a defined numerical quantity of data transactions that can be executed from a defined geographic location (e.g., of the client device 102 and/or of a user of the client device 102) and/or from a defined geographic location within a threshold time period, where the numerical quantity of transactions is based on the geographic location of the client device 102 and/or the user of the client device 102. For example, the account can have a defined numerical quantity of data transactions set to 5 data transactions for a geographic location (e.g., and/or within a threshold time period from the geographic location) that is a known geographic location for the user of the client device 102 and/or the client device 102. Example known geographic locations can include, but are not limited to, a home of the user, an office of the user, or any other location frequently visited by the user. The account can have a defined numerical quantity of data transactions set to 1 data transaction for a geographic location that is not a known geographic location for the user of the client device 102 and/or the client device 102. If the user of the client device 102 and/or the client device 102 moves from a known geographic location, then the numerical quantity of data transactions that can be executed can change from 5 to 1. In some variations, a user can provide a list of known geographic locations to the client device 102 as user input. In some other variations, the client device 102 can monitor the geographic location of the client device 102 and/or of the user of the client device 102 to determine a frequency and/or pattern over which the client device 102 visits the geographic locations. The client device 102 can determine the list of known geographic locations from the frequency and/or pattern (e.g., where the list of known geographic locations include geographic locations that the client device 102 and/or the user of the client device 102 most frequently visits).

Additionally, or alternatively, the account can have a defined numerical quantity of data transactions that can be executed based on a wireless network (e.g., a known network vs. unknown network, including one or more Wi-Fi networks and/or cellular networks). For example, the account can have a defined numerical quantity of data transactions set to 5 data transactions for a known network (e.g., a network that the client device 102 frequently uses to establish a wireless connection) and 1 data transaction for an unknown network. If a wireless connection of a client device 102 changes from a known network to an unknown wireless network, then the numerical quantity of data transactions that can be executed can change from 5 to 1. In some variations, a user can provide a list of known networks to the client device 102 as user input. In some other variations, the client device 102 can monitor the network connections to determine a frequency and/or pattern over which the client device 102 connects to different networks. The client device 102 can determine the list of known networks from the frequency and/or pattern (e.g., where the list of known networks include networks that the client device 102 most frequently connects to). In some examples, any combination of conditions can be met prior to the data transaction manager 110 determining to execute the data transaction.

The condition detection component 118 can monitor the conditions to detect whether one or more conditions for execution of the data transaction are satisfied or not. In some variations, the condition detection component 118 can determine the one or more conditions are not satisfied if a network connection is unstable or weak (e.g., one or more of the characteristics of the network connection fail to satisfy respective threshold values), a network connection is not established with the payment service 104, a stored balance of a user account fails to satisfy a threshold value, if a threshold numerical quantity of data transactions over a time period for the account is exceeded, if a threshold numerical quantity of data transactions for a current location (e.g., of the client device 102 and/or of the user of the client device 102) is exceeded, or if a threshold value of data transactions for the current location is exceeded. In some other variations, the condition detection component 118 can determine the one or more conditions are satisfied if a network connection is stable (e.g., one or more of the characteristics of the network connection satisfy respective threshold values), a network connection is established with the payment service 104, a stored balance of a user account satisfies a threshold value, if a time period is reset, such that a threshold numerical quantity of data transactions over the time period for the account is below a threshold value, and/or if a geographic location of a user of the client device 102 or the client device 102 changes, such that a numerical quantity of data transactions or a value of data transactions associated with the current location is below a threshold value.

If one or more of the conditions are not satisfied, then the client device 102 may not execute the data transaction or may attempt to execute the data transaction, where the data transaction fails to execute. The client device 102 can display a notification (e.g., an error message) via the user interface 114 indicating the failure to execute the data transaction. The notification can include an indication of a condition that prevented the data transaction from executing. A user may determine to wait for a time period prior to providing additional input initiating execution of the data transaction again. However, the user may forget to initiate the data transaction again until after a deadline or time period for executing the data transaction has passed. If the data transaction includes a payment for a bill that is due at the end of a time period, such as a day, a week, a month, or any other time period, then failure to execute the data transaction during the time period can result in additional payments (e.g., a penalty), as well as other consequences for the user. Further, the user may manually monitor the conditions (e.g., a network connection, a server availability, a stored balance, etc.), to determine whether one or more conditions are met for execution of the data transaction. However, manually monitoring the conditions results in increased power consumption at the client device 102 due to display of the conditions via the user interface 114, as well as inefficient use of computational resources (e.g., processing and memory resources).

In some examples, the client device 102 can receive input initiating or triggering execution of the data transaction, and the condition detection component 118 can detect at least one condition is not met for execution of the data transaction. The condition detection component 118 can identify a type of the condition that is not met or satisfied. The type of the condition can include, but is not limited to, a lack of a network connection with the networks 106, server maintenance for the payment service 104, a weak network connection (e.g., less than a threshold strength), insufficient stored balance to withdraw a value for the data transaction, a numerical quantity of withdrawals for a user account being exceeded for a time period (e.g., a day, a week, a month), and/or a numerical quantity of withdrawal for a user account being exceeded for a defined geographic location and/or network connection. In some examples, the data transaction manager 110 can indicate for the client device 102 to display a request to the user via the user interface 114 for activation of automatic execution of the data transaction when the conditions are met or satisfied, which is described in further detail with respect to FIGS. 3 and 4. In some other examples, the data transaction manager 110 can activate automatic execution of the data transaction when the conditions are met or satisfied (e.g., without receiving user input). Additionally, or alternatively, the client device 102 can display a control that is selectable by a user to indicate a maximum time period for automatic execution of the data transaction, such that the client device 102 monitors the conditions for execution of the data transaction until the end of the maximum time period. In some variations, the client device 102 may select the maximum time period (e.g., a default maximum time period) independent of or without user input.

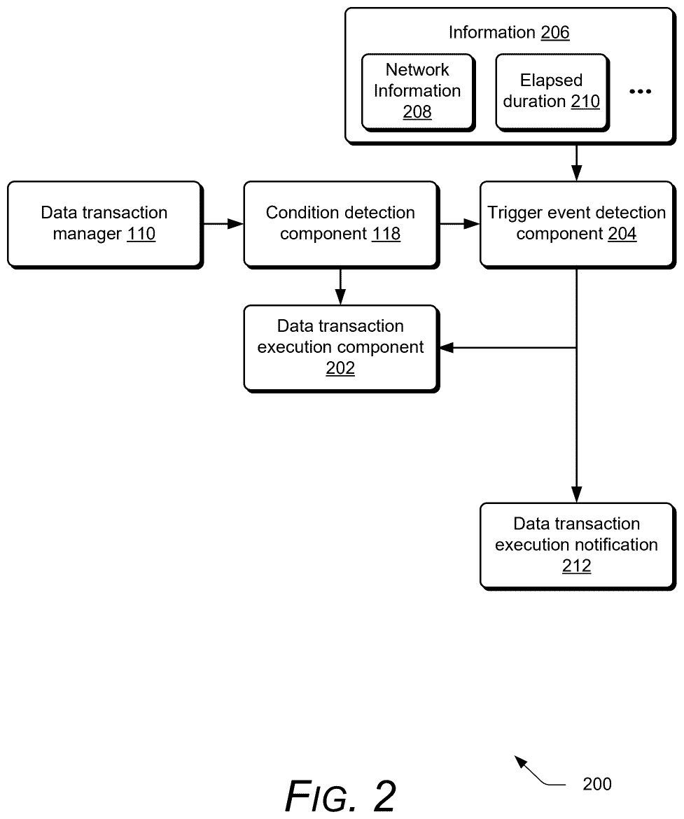

The condition detection component 118 monitors the conditions to detect whether conditions for execution of the data transaction are satisfied, which is described in further detail with respect to FIG. 2. If the conditions are satisfied, then the client device 102 executes the data transaction. The condition detection component 118 discontinues monitoring the conditions, and the client device 102 can display a notification to the user via the user interface 114 that indicates the data transaction is successfully executed. In some examples, the condition detection component 118 monitors the conditions during the maximum time period specified by user input and/or selected by the client device 102. If the maximum time period expires, then the condition detection component 118 discontinues monitoring the conditions, and the client device 102 can display a notification to the user via the user interface 114 that indicates a failure to execute the data transaction during the maximum time period.

FIG. 2 illustrates an example system 200 for condition-based data transactions in accordance with one or more implementations as described herein. The example system 200 may implement aspects of the example system 100. For example, the example system 200 can be implemented by a data transaction manager 110 that implements a condition detection component 118 to monitor conditions for execution of a data transaction, where the data transaction manager 110 and the condition detection component 118 may be examples of the corresponding devices as described with reference to FIG. 1.

In some examples, a data transaction manager 110 receives input initiating execution of a data transaction. A user may provide input via one or more controls displayed via a user interface of a client device (e.g., a user interface 114 of a client device 102, as described with reference to FIG. 1) that are selectable by the user to initiate execution of the data transaction. The data transaction manager 110 implements a condition detection component 118 to determine whether one or more conditions are satisfied for execution of the data transaction, as described with reference to FIG. 1.

In some examples, if the conditions are satisfied, then a data transaction execution component 202 can execute the data transaction. In some other examples, if the conditions are not satisfied, then a trigger event detection component 204 may monitor for a change in the conditions. The trigger event detection component 204 may monitor for the change in the conditions if a user provides input activating automatic execution of the data transaction and/or if a client device activates automatic execution of the data transaction. In some variations, the trigger event detection component 204 is implemented at the condition detection component 118. In some other variations, the trigger event detection component 204 is a component implemented separate from the condition detection component 118. For example, the trigger event detection component 204 can be implemented at a server device (e.g., instead of at a client device). If the trigger event detection component 204 is implemented at a server device, then the trigger event detection component 204 can inform the condition detection component 118 via a public subscription mechanism (e.g., an event subscription or a webhook subscription, among other public subscription mechanisms) when the data transaction can be executed again.

The trigger event detection component 204 receives information 206 collected by a client device. The information 206 includes, but is not limited to, network information 208 and an elapsed duration 210, among other information. The network information 208 can include current characteristics of a network connection between a client device that implements the trigger event detection component 204 and a payment service (e.g., a payment service 104 as described with reference to FIG. 1). For example, the network information 208 can include a current strength of the network connection, a current type of the network connection, and/or a current speed of the network connection. In some cases, the elapsed duration 210 can include a duration between when initial input indicating for the data transaction manager 110 to execute the data transaction is received and a current time. In some other cases, the elapsed duration 210 can include a duration between when a user provides input activating automatic execution of the data transaction when the conditions are satisfied and a current time. The information 206 can additionally, or alternatively, include information related to a server maintenance status or availability status of a server of a payment service. The status of the server can include a value indicating whether the server is available, whether the server is being maintained, or the like.

The information 206 can additionally, or alternatively, include information related to the value of a stored balance for a user account, or any changes therein. The information 206 can additionally, or alternatively, include information related to a threshold numerical quantity of additional data transactions permitted within a defined time period for a user account, along with any subsequent modifications, including the resetting of the time period to ensure that the cumulative quantity of data transactions within the account remains below a predetermined threshold. The information 206 may further include information associated with a predetermined threshold governing either the quantity of supplementary data transactions permitted within a specified time period for a user account, or the cumulative value of data transactions authorized at a designated location for the user account. Additionally, or alternatively, the information 206 may incorporate details concerning any subsequent alterations to the designated location, implemented to ensure that a total number or cumulative value of data transactions executed for the user account remains below a predetermined threshold value.

The trigger event detection component 204 can monitor the conditions until a trigger event is detected. The trigger event can include a change in one or more of the conditions, such that the conditions are satisfied. For example, the trigger event can include, but is not limited to, the client device establishing a network connection for transmitting and receiving signaling to and from a payment service, a server of the payment service becoming available, a strength of a network connection exceeding a threshold value, a speed of a network connection exceeding a threshold value, a type of a network connection being a defined type of network connection, a time period resetting, where a threshold numerical quantity of data transactions can be executed during the time period, and/or a change to the user location, where a threshold numerical quantity of data transactions can be executed. The trigger event detection component 204 can determine the time period is reset based on the elapsed duration 210. The trigger event detection component 204 can determine a network connection is established and/or one or more characteristics of the network connection (e.g., strength, speed, type, etc.) are satisfied by comparing the network information 208 to respective thresholds and/or defined values for the characteristics that correspond to a trigger event.

If the trigger event detection component 204 detects a trigger event for executing the data transaction (e.g., if the conditions for execution of the data transaction are satisfied), then the data transaction execution component 202 of the client device executes the data transaction. In some examples, the client device can display a data transaction execution notification 212 via a user interface. In some cases, the data transaction execution notification 212 can include a message that indicates the data transaction is successfully executed if the data transaction execution component 202 executes the data transaction. In some other cases, the data transaction execution notification 212 can include a message that indicates the data transaction is not executed if the trigger event detection component 204 fails to detect a trigger event for executing the data transaction prior to expiry of a timer or prior to an expiry time elapsing (e.g., the elapsed duration exceeds a defined maximum time period for automatic execution of the data transaction).

FIG. 3 illustrates an example user interface 300 for condition-based data transactions in accordance with one or more implementations as described herein. The user interface 300 may implement aspects of the example system 100 and/or the example system 200, as shown and described with reference to FIGS. 1 and 2. For example, the example user interface 300 may include a client device 102 for scheduling a data transaction based on conditions for execution of the data transaction, where the client device 102 may be an example of a client device 102 as described with reference to FIG. 1. In some variations, the client device 102 includes respective user interfaces 114 that display an application 112, which may be examples of user interfaces 114 and an application 112 as described with reference to FIG. 1.

A client device 102 can detect a request to initiate execution of a data transaction. For example, the client device 102 can receive user input (e.g., via the instance of the application 112) that initiates execution of the data transaction. The data transaction can include an exchange of signaling with a payment service (e.g., a payment service 104 as described with reference to FIG. 1) to facilitate withdrawal of a value from a stored balance of a user account and credit of the value to another user account and/or to a merchant account. The value can include a total payment value, such as $100.00. In some examples, the client device 102 detects an error condition that prevents or impacts execution of the data transaction. An error condition can include a condition not being met or failing to be satisfied for execution of the data transaction, as described with reference to FIGS. 1 and 2.

At a first time, the client device 102 can output a notification 302 for display at the user interface 114 that indicates the error condition is detected. The notification 302 can include one or more strings and/or characters, referred to as a text value. For example, the notification 302 can include a text value, “Error condition detected. Payment mode changed to: Scheduled Transaction.” The client device 102 can activate automatic execution of the data transaction once the error condition is resolved, referred to as a scheduled transaction payment mode. That is, the data transaction is scheduled to execute when the conditions for execution of the data transaction are satisfied.

The client device 102 can additionally, or alternatively, display one or more interactable elements 304 to the user of the client device 102 via the user interface 114 of the application 112. The interactable elements 304 can include, but are not limited to, button elements, drop-down menus, text field elements, or the like. The client device 102 can receive user input selecting one or more of the interactable elements 304. For example, a user of the client device 102 can provide user input selecting a button element labeled with “Schedule for later” to confirm activation of the schedule transaction payment mode (e.g., by clicking the button element). In some other examples, the user of the client device 102 can provide user input selecting a button element labeled with “Cancel” to cancel activation of the schedule transaction payment mode.

In some examples, such as if the user of the client device 102 selects the button element that confirms activation of the schedule transaction payment mode, the client device 102 displays a prompt 306 via the user interface 114 at a later time. The prompt requests information from a user of the client device 102, such as a password (e.g., a four-digit password). For example, the prompt 306 can include a text value “Insert your password:,” as well as one or more fields for a user to provide input including the password. The password can include any numerical quantity of values, including, but not limited to, numerical values (e.g., 1, 2, 3, 4). The client device 102 can verify a password based on comparing the values input by a user to one or more stored values representative of a password for a user of the client device 102.

The client device 102 can display one or more additional interactable elements 308 to the user of the client device 102 via the user interface 114 of the application 112. The additional interactable elements 308 can include, but are not limited to, button elements, drop-down menus, text field elements, or the like. The client device 102 can receive user input selecting one or more of the additional interactable elements 308 upon verification of the password. For example, a user of the client device 102 can provide user input selecting a button element labeled with “Schedule” to schedule the data transaction to execute when the conditions are satisfied for execution of the data transaction (e.g., by clicking the button element). In some other examples, the user of the client device 102 can provide user input by selecting a button element labeled with “Cancel” to cancel scheduling of the data transaction to execute when the conditions are satisfied.

In some examples, such as if the user of the client device 102 selects the button element that schedules execution of the data transaction and if the password is verified, then the client device 102 displays an additional notification 310 via the user interface 114. The additional notification 310 includes a text value indicating that the scheduling of the data transaction is successful. For example, the additional notification 310 includes the text value, “Scheduling Successful. Your transaction will be executed automatically when the conditions are satisfied,” or “Scheduling Successful. Your transaction will be executed automatically when the error conditions are resolved.” The client device 102 can optionally display one or more interactable elements 312, including a button element labeled with “Done” to close the additional notification 310 and, in some examples, a button element labeled with “Set schedule expiry.” In some variations, when selected, the button element labeled with “Set scheduled expiry,” displays one or more controls selectable by a user to input a maximum time period over which the data transaction is scheduled to execute. The client device 102 can select the maximum time period over which the data transaction is scheduled to execute (e.g., as a default maximum time period) in addition to, or as an alternative to, the controls selectable by the user to indicate the maximum time period. For example, if the user does not select a maximum time period, then the client device 102 selects the maximum time period. Once the scheduling of the data transaction is confirmed (e.g., if the user selects the additional interactable element 308 labeled with “Schedule”), then the client device 102 can monitor for a trigger event from a change in one or more conditions, as described with reference to FIG. 2.

FIG. 4 illustrates an example user interface 400 for condition-based data transactions in accordance with one or more implementations as described herein. The user interface 400 may implement aspects of the example system 100, the example system 200, and/or the user interface 300, as shown and described with reference to FIGS. 1 through 3. For example, the example user interface 400 may include a client device 102 executing a scheduled data transaction based on conditions being satisfied for execution of the data transaction, where the client device 102 may be an example of a client device 102 as described with reference to FIG. 1. In some variations, the client device 102 includes respective user interfaces 114 that display an application 112, which may be examples of user interfaces 114 and an application 112 as described with reference to FIG. 1.

In some variations, a data transaction is scheduled to execute (e.g., during a time period) if one or more conditions are satisfied for execution of the data transaction, as described with reference to FIGS. 1 through 3. For example, the client device 102 can monitor information 206 to detect a change in one or more conditions, where the information 206 may be an example of the information 206 as described with reference to FIG. 2. The client device 102 can execute the data transaction (e.g., automatically without user input initiating execution of the data transaction) upon detection that the conditions are satisfied during the time period. The client device 102 can display a data transaction execution notification (e.g., a data transaction execution notification 212, as described with reference to FIG. 2) as a notification 402 indicating that the data transaction is executed. The notification 402 can include one or more strings and/or characters, referred to as a text value. For example, the notification 402 can include a text value, “Scheduled Transaction Completed. Your scheduled transaction of $100.00 is completed,” where $100.00 is the total value of a payment data transaction.

The client device 102 can additionally, or alternatively, display one or more interactable elements 404 to the user of the client device 102 via the user interface 114 of the application 112. The interactable elements 404 can include, but are not limited to, button elements, drop-down menus, text field elements, or the like. The client device 102 can receive user input selecting one or more of the interactable elements 404. For example, a user of the client device 102 can provide user input selecting a button element labeled with “View Receipt” to indicate to the client device 102 to display one or more details of the data transaction via the user interface 114 (e.g., by clicking the button element). The details of the data transaction can include a total value of the data transaction, a date and time of execution of the data transaction, and a user account or merchant account that receives the total value of the data transaction, among other information. In some other examples, the user of the client device 102 can provide user input selecting a button element labeled with “Done” to acknowledge the notification 402.

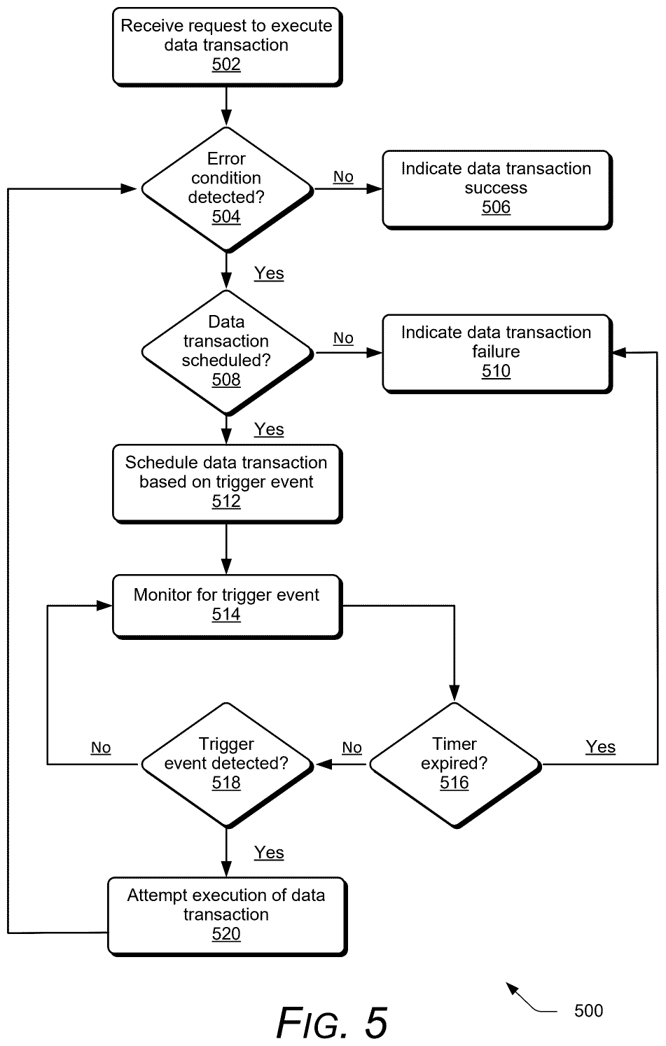

FIG. 5 illustrates an example flowchart 500 for condition-based data transactions in accordance with one or more implementations as described herein. The flowchart 500 may implement aspects of the system 100, as well as any of the system 200, the user interface 300, or the user interface 400. For example, the example flowchart 500 can be implemented by a client device 102, which may be an example of the client device 102 as described with reference to FIGS. 1 through 4. Alternative examples of the following may be implemented, where some processes are performed in a different order than described or are not performed. In some cases, processes may include additional features not mentioned below, or further processes may be added.

At 502, a request to execute a data transaction is received. For example, a client device (e.g., a client device 102, as described with reference to FIGS. 1 through 4) can receive user input via an interactable element of a user interface displayed at the client device. The user interface can display an application, where the interactable elements are a feature of the application. The application may be a purchase and/or payment application, such as a digital banking application that enables functionality to transfer a value to another user account and/or to a merchant account (e.g., using a stored balance of a user account). The user input can indicate for the client device to execute a data transaction, where the data transaction includes transfer of a value from a stored balance of a user account to another user account and/or to a merchant account. The client device can transmit and/or receive signaling to and from a payment service (e.g., a payment service 104, as described with reference to FIG. 1) indicating the value.

At 504, a determination is made as to whether an error condition is detected. For example, a client device detects a condition that causes a failure to execute the data transaction at a first time. The condition can include, but is not limited to, a network connection status, one or more characteristics of a network connection, a server status, a stored balance associated with the payment service, a threshold numerical quantity of data transactions associated with the payment service for a duration of a timer (e.g., over a time period), a threshold numerical quantity of data transactions associated with the current geographic location of the user and/or the client device, or a threshold value of data transactions associated with the current geographic location of the user and/or the client device.

At 506, if the error condition is not detected (e.g., “No”), then the data transaction is executed, and a notification is output indicating that the data transaction is successful. For example, the client device detects that a network connection is established, that characteristics of the network connection (e.g., speed, type, strength) satisfy one or more defined or threshold values, that a server is available, that a threshold numerical quantity of data transactions is not exceeded during the timer and that a threshold numerical quantity of data transactions or a value of a data transaction is not exceeded at given geographic location. The client device can execute the data transaction by transmitting or receiving signaling to or from a payment service that transfers a value from a stored balance of a user account of the application to another user account and/or to a merchant account. The value can be transferred by use of a payment instrument, which can be linked to the user account, as described with reference to FIG. 1. The client device can output a notification for display that includes a text value indicating that the data transaction is successfully executed, as described with reference to FIG. 4.

At 508, if the error condition is detected (e.g., “Yes”), then a determination is made as to whether a data transaction is scheduled. For example, the client device can schedule the data transaction to execute at a later time upon detection of a trigger event, as described with reference to FIG. 2. The trigger event can include a change in one or more conditions, such that the conditions are satisfied for execution of the data transaction. In some variations, the client device schedules the data transaction to execute once the conditions are satisfied independent of user input (e.g., without receiving user input). In some other variations, the client device outputs a notification to the user along with one or more interactable elements selectable by the user to indicate for the client device to schedule the data transaction to execute when the conditions are satisfied, as described with reference to FIG. 3. For example, the client device outputs a control via a user interface of the client device, where the control is selectable to cause execution of the data transaction based on a detection of the change in the condition corresponding to the failure to execute the data transaction.

In some examples, at 510, if the data transaction is not scheduled (e.g., “No”), then a notification is output indicating that the data transaction has failed. For example, the client device receives user input indicating for the client device to refrain from scheduling (e.g., not schedule) the data transaction to execute once the conditions are satisfied. The client device can output a notification for display that includes a text value indicating that the data transaction has failed based on the user input. In some other examples, at 512, the data transaction is scheduled based on a trigger event (e.g., “Yes”). For example, the client device can schedule the data transaction to execute when one or more conditions for execution of the data transaction are satisfied, where the trigger event includes the one or more conditions being satisfied. The client device can receive a selection via the control that indicates for the client device to execute the data transaction based on the detection of the change in the condition corresponding to the failure to execute the data transaction.

At 514, the trigger event is monitored. For example, a client device obtains information (e.g., the information 206, as described with reference to FIG. 2) related to the trigger event and determines one or more current conditions from the information. If the current conditions satisfy one or more threshold values or defined values, then the conditions for execution of the data transaction are met and the trigger event is detected.

In some variations, a maximum time period for monitoring for the trigger event and subsequently executing the data transaction when the trigger event is detected can be defined (e.g., selected by the client device and/or specified by user input). For example, at 516, a determination is made as to whether the timer is expired. At 510, if the timer is expired (e.g., “Yes”), then a notification is output indicating that the data transaction has failed. For example, the client device can indicate that the data transaction has failed if the maximum time period is exceeded. the client device can receive user input via an interactable element of a user interface displayed at the client device. The user input can indicate a timer and/or an expiry time associated with executing the data transaction. In some examples, the client device can initiate the timer at the first time. For example, the client device can start a timer with a value equal to the maximum time period (e.g., the expiry time) upon the data transaction being scheduled (e.g., at 512). In some variations, the client device attempts to execute the data transaction once the timer expires, or the expiry time elapses without detection of a trigger event. In some other variations, the client device cancels the data transaction once the timer expires or the expiry time elapses without detection of a trigger event and indicates the data transaction failure (e.g., at 510).

The client device can output a notification for display once the timer expires without detection of a trigger event, where the notification indicates that the data transaction has failed. If the client device attempts to execute the data transaction once the timer expires without detection of the trigger event, and if the attempt is successful, then the client device can output a notification for display that indicates that the data transaction is successful. Thus, the client device can output a message for display via a user interface of the client device that indicates a status of the execution of the data transaction at the second time after the first time. At 506, the status includes a successful execution of the data transaction. At 510, the status includes a failure to execute the data transaction.

At 518, if the timer is not expired (e.g., “No”), then a determination is made as to whether the trigger event is detected. The determination can include the client device detecting a change from a first network connection status to a second network connection status, detecting a change from one or more first characteristics of a network connection to one or more second characteristics of the network connection, detecting a change from a first server status to a second server status, detecting a change in a value of a stored balance associated with the payment service, detecting expiry of a timer corresponding to a threshold numerical quantity of data transactions associated with the payment service, detecting expiry of a timer with a threshold transaction value for the data transaction, detecting a change to a geographic location with a greater threshold numerical quantity of data transactions for the payment service, detecting a change to a geographic location with a greater threshold transaction value for the data transaction, and/or detecting a change to at least one of a numerical quantity of data transactions for a geographic location or a threshold transaction value for one or more data transactions within the geographic location.

At 520, if the trigger event is detected (e.g., “Yes”), then execution of the data transaction is attempted. The client device can execute the data transaction a second time after the first time based on a change in the condition corresponding to the failure to execute the data transaction. For example, if a network connection is established, one or more characteristics of the network connection satisfy respective threshold or defined values, a server of a payment service is available, and a numerical quantity of data transactions over a time period is less than a threshold value, then the conditions are satisfied, and the trigger event is detected. Upon execution of the data transaction, the client device can return to 504 to determine whether an error condition is detected. If the error condition is detected (e.g., “Yes”), then the client device can repeat the process from 508 to 520. If the error condition is not detected (e.g., “No”), then the client device can output a notification for display that indicates that the data transaction is successful. In some examples, at 520, if the trigger event is detected (e.g., “Yes”), then the client device outputs a notification to the user along with one or more interactable elements selectable by the user to indicate for the client device to execute the data transaction. If the trigger event is not detected at 518 (e.g., “No”), then the trigger event is monitored. For example, the client device may continue to monitor for the trigger event until the trigger event is detected.

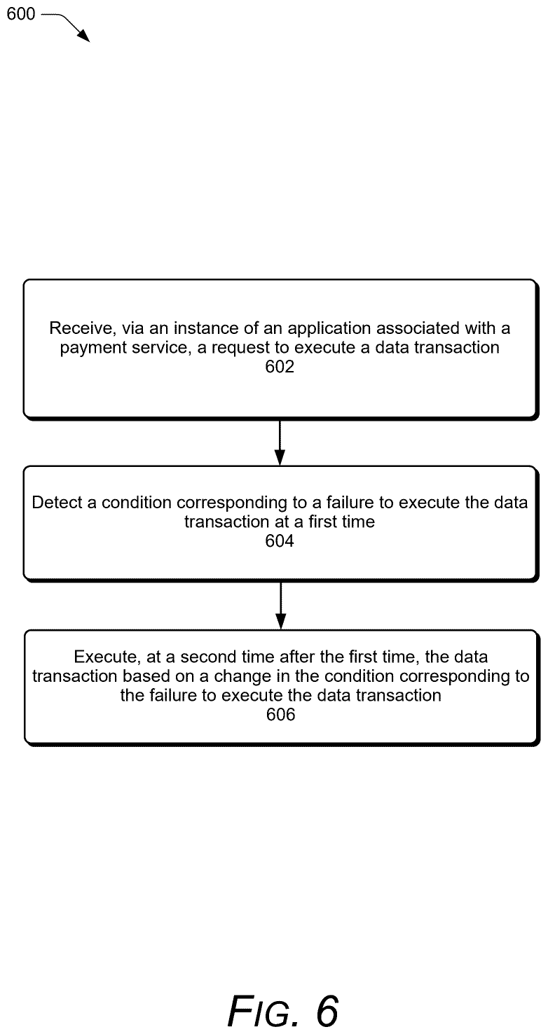

The example flowchart 500, as well as example method 600, are described with reference to respective FIGS. 5 and 6 in accordance with one or more implementations of condition-based data transactions, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates one or more example methods 600 for condition-based data transactions. The order in which the method is described is not intended to be construed as a limitation, and any number or combination of the described method operations can be performed in any order to perform a method, or an alternate method.

At 602, a request to execute a data transaction is received via an instance of an application associated with a payment service. For example, a client device receives user input via an interactable element of a user interface displayed at the client device indicating the request to execute the data transaction.

In some examples, the client device outputs a control for display via a user interface of the client device that is selectable to cause execution of the data transaction based on a detection of the change in the condition corresponding to the failure to execute the data transaction. The client device receives a selection via the control that indicates for the client device to execute the data transaction based on the detection of the change in the condition corresponding to the failure to execute the data transaction.

At 604, a condition corresponding to a failure to execute the data transaction at a first time is detected. In some cases, the condition corresponding to the failure to execute the data transaction at the first time includes at least one of a network connection status, one or more characteristics of a network connection, a server status, a stored balance associated with the payment service, a threshold numerical quantity of data transactions associated with the payment service for a duration of a timer, a threshold numerical quantity of data transactions associated with the current geographic location of the user, or a value of data transactions associated with the current geographic location of the user, among other conditions.

In some cases, the client device receives user input via an interactable element of a user interface displayed at the client device indicating a timer and/or an expiry time associated with executing the data transaction. The client device initiates the timer at the first time.

In some cases, the client device receives user input via an interactable element of a user interface displayed at the client device indicating a threshold numerical quantity of data transactions for one or more geographic locations and/or a threshold transaction value for one or more geographic locations.

At 606, the data transaction is executed at a second time after the first time based on a change in the condition corresponding to the failure to execute the data transaction. In some examples, the client device executes the data transaction based on detecting expiry of the timer or based on detecting the expiry time. For example, the elapsed duration between the second time and the first time can be equal to the duration of the timer and/or to the expiry time.

In some cases, the client device detects the change in the condition corresponding to the failure to execute the data transaction. Detecting the change in the condition corresponding to the failure to execute the data transaction includes at least one of detecting a change from a first network connection status to a second network connection status, detecting a change from one or more first characteristics of a network connection to one or more second characteristics of the network connection, detecting a change from a first server status to a second server status, detecting a change in a value of a stored balance associated with the payment service, detecting expiry of a timer corresponding to a threshold numerical quantity of data transactions associated with the payment service, detecting expiry of a timer corresponding to a threshold transaction value associated with the data transaction, detecting a change to a geographic location corresponding to a greater threshold numerical quantity of data transactions or value of data transactions, detecting a change to a geographic location corresponding to a greater threshold transaction value associated with the data transaction, or detecting a change to at least one of a numerical quantity of data transactions associated with a geographic location or a threshold transaction value for one or more data transactions associated with the geographic location.

The client device outputs a message for display via a user interface of the client device that indicates a status of the execution of the data transaction at the second time after the first time, where the status includes at least one of a successful execution of the data transaction or a failure to execute the data transaction (e.g., at the second time).

FIG. 7 illustrates various components of an example device 700, which can implement aspects of the techniques and features for condition-based data transactions, as described herein. The example device 700 can be implemented as any of the devices described with reference to the previous FIGS. 1 through 6, such as any type of a wireless device, mobile device (e.g., the client device 102), mobile phone, flip phone, client device, companion device, paired device, display device, tablet, computing, communication, entertainment, gaming, media playback, and/or any other type of computing, consumer, and/or electronic device. For example, the client device 102 described with reference to FIGS. 1 through 6 may be implemented as the example device 700.

The example device 700 can include various, different communication devices 702 that enable wired and/or wireless communication of device data 704 with other devices. The device data 704 can include any of the various device's data and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input/output (I/O) interfaces 706, such as data network interfaces that provide connection and/or communication links between the devices, data networks, and other devices. The I/O interfaces 706 can be used to couple the device to any type of components, peripherals, and/or accessory devices, such as a computer input device that may be integrated with the example device 700. The I/O interfaces 706 may also include data input ports via which any type of data, information, media content, communications, messages, and/or inputs can be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that may be implemented in connection with processing and control circuits, which are generally identified as processing and control 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 712 include volatile memory and non-volatile memory, fixed and removable media devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage media device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 can be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In this example, the device 700 includes a data transaction manager 718 that implements various aspects of the described features and techniques described herein. The data transaction manager 718 can be implemented with hardware components and/or in software as one of the device applications 714, such as when the example device 700 is implemented as the client device 102 described with reference to FIGS. 1 through 6. An example of the data transaction manager 718 is the data transaction manager 110 implemented in the client device 102, such as a software application and/or as hardware components in the wireless device. In one or more implementations, the data transaction manager 718 may include independent processing, memory, and logic components as a computing and/or electronic device integrated with the example device 700.

The example device 700 can also include a microphone 720 and/or camera devices 722, as well as proximity and/or motion sensors 724, such as may be implemented as components of an inertial measurement unit (IMU), and geographical location information sensors (e.g., GPS to obtain a current geographic location of the client device executing the data transaction or a user of the client device). The proximity and/or motion sensors 724 can be implemented with various sensors 726, such as a gyroscope, an accelerometer, and/or other types of motion sensors to sense motion of the device. The motion sensors 724 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources, such as when the device is implemented as a wireless device and/or a client device 102. The power sources may include a charging and/or power system, and can be implemented as a flexible strip battery, a rechargeable battery, a charged super-capacitor, and/or any other type of active or passive power source.

The example device 700 can also include an audio and/or video processing system 728 that generates audio data for an audio system 730 and/or generates display data for a display system 732. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In one or more implementations, the audio system and/or the display system are integrated components of the example device 700. Alternatively, the audio system and/or the display system are external, peripheral components to the example device.

In some aspects, the techniques described herein relate to a client device including one or more processors, and one or more memory configured to cause the one or more processors to receive, via an application associated with a payment service, a request to execute a data transaction, detect a condition corresponding to a failure to execute the data transaction at a first time, and execute, at a second time after the first time, the data transaction based on a change in the condition corresponding to the failure to execute the data transaction.

In some aspects, the techniques described herein relate to a client device, where the one or more processors are further configured to output, for display via a user interface of the client device, a control that is selectable to cause execution of the data transaction based on a detection of the change in the condition corresponding to the failure to execute the data transaction.

In some aspects, the techniques described herein relate to a client device, where the one or more processors are further configured to receive a selection via the control that indicates for the client device to execute the data transaction based on the detection of the change in the condition corresponding to the failure to execute the data transaction.

In some aspects, the techniques described herein relate to a client device, where the one or more processors are further configured to output, for display via a user interface of the client device, a message that indicates a status of the execution of the data transaction at the second time after the first time, where the status includes at least one of a successful execution of the data transaction or a failure to execute the data transaction.

In some aspects, the techniques described herein relate to a client device, where the one or more processors are further configured to detect the change in the condition corresponding to the failure to execute the data transaction, and where detecting the change in the condition corresponding to the failure to execute the data transaction includes at least one of detecting a change from a first network connection status to a second network connection status, detecting a change from one or more first characteristics of a network connection to one or more second characteristics of the network connection, detecting a change from a first server status to a second server status, detecting a change in a value of a stored balance associated with the payment service, where the value of the stored balance satisfies a threshold value corresponds to a transaction value associated with the data transaction, detecting a change in a threshold transaction value associated with the data transaction, detecting expiry of a timer corresponding to a threshold numerical quantity of data transactions associated with the payment service, detecting expiry of a timer corresponding to a threshold transaction value associated with the data transaction, detecting a change to a geographic location corresponding to a greater threshold numerical quantity of data transactions associated with the payment service, detecting a change to a geographic location corresponding to a greater threshold transaction value associated with the data transaction, or detecting a change to at least one of a numerical quantity of data transactions associated with a geographic location or a threshold transaction value for one or more data transactions associated with the geographic location.

In some aspects, the techniques described herein relate to a client device, where the one or more processors are further configured to receive, via an interactable element of a user interface displayed at the client device, user input indicating at least one of a threshold numerical quantity of data transactions associated with respective geographic locations of a set of geographic locations or a threshold transaction value associated with the respective geographic locations of the set of geographic locations.

In some aspects, the techniques described herein relate to receive, via an interactable element of a user interface displayed at the client device, user input indicating an expiry time associated with executing the data transaction.

In some aspects, the techniques described herein relate to a client device, where the one or more processors are further configured to execute the data transaction based on detecting the expiry time.

In some aspects, the techniques described herein relate to a client device, where to receive the request to execute the data transaction, the one or more processors are configured to receive, via an interactable element of a user interface displayed at the client device, user input indicating the request to execute the data transaction.

In some aspects, the techniques described herein relate to a client device, where the condition corresponding to the failure to execute the data transaction at the first time includes at least one of a network connection status, one or more characteristics of a network connection, a server status, a value of a stored balance associated with the payment service, a threshold numerical quantity of data transactions associated with the payment service for a duration of a timer, a threshold numerical quantity of data transactions associated with a geographic location, or a threshold transaction value associated with the geographic location.

In some aspects, the techniques described herein relate to a method including receiving, at a client device and via an application associated with a payment service, a request to execute a data transaction, detecting a condition corresponding to a failure to execute the data transaction at a first time, and executing, at a second time after the first time, the data transaction based on a change in the condition corresponding to the failure to execute the data transaction.

In some aspects, the techniques described herein relate to a method, further including outputting, for display via a user interface of the client device, a control that is selectable to cause execution of the data transaction based on a detection of the change in the condition corresponding to the failure to execute the data transaction.

In some aspects, the techniques described herein relate to a method, further including outputting, for display via a user interface of the client device, a message that indicates a status of the execution of the data transaction at the second time after the first time, where the status includes at least one of a successful execution of the data transaction or a failure to execute the data transaction.

In some aspects, the techniques described herein relate to a method, further including detecting the change in the condition corresponding to the failure to execute the data transaction, where detecting the change in the condition corresponding to the failure to execute the data transaction includes at least one of detecting a change from a first network connection status to a second network connection status, detecting a change from one or more first characteristics of a network connection to one or more second characteristics of the network connection, detecting a change from a first server status to a second server status, detecting a change in a value of a stored balance associated with the payment service, where the value of the stored balance satisfies a threshold value corresponds to a transaction value associated with the data transaction, detecting a change in a threshold transaction value associated with the data transaction, detecting expiry of a timer corresponding to a threshold numerical quantity of data transactions associated with the payment service, detecting expiry of a timer corresponding to a threshold transaction value associated with the data transaction, detecting a change to a geographic location corresponding to a greater threshold numerical quantity of data transactions associated with the payment service, detecting a change to a geographic location corresponding to a greater threshold transaction value associated with the data transaction, or detecting a change to at least one of a numerical quantity of data transactions associated with a geographic location or a threshold transaction value for one or more data transactions associated with the geographic location.

In some aspects, the techniques described herein relate to receiving, via an interactable element of a user interface displayed at the client device, user input indicating an expiry time associated with executing the data transaction.

In some aspects, the techniques described herein relate to a method, where receiving the request to execute the data transaction includes receiving, via an interactable element of a user interface displayed at the client device, user input indicating the request to execute the data transaction.

In some aspects, the techniques described herein relate to a method, where the condition corresponding to the failure to execute the data transaction at the first time includes at least one of a network connection status, one or more characteristics of a network connection, a server status, a value of a stored balance associated with the payment service, a threshold numerical quantity of data transactions associated with the payment service for a duration of a timer, a threshold numerical quantity of data transactions associated with a geographic location, or a threshold transaction value associated with the geographic location.

In some aspects, the techniques described herein relate to a system including one or more processors, and computer-readable storage media storing instructions that are executable by the one or more processors to receive, at a client device and via an application associated with a payment service, a request to execute a data transaction, detect a condition corresponding to a failure to execute the data transaction at a first time, and execute, at a second time after the first time, the data transaction based on a change in the condition corresponding to the failure to execute the data transaction.

In some aspects, the techniques described herein relate to a system, where the instructions are further executable by the one or more processors to output, for display via a user interface of the client device, a control that is selectable to cause execution of the data transaction based on a detection of the change in the condition corresponding to the failure to execute the data transaction.

In some aspects, the techniques described herein relate to a system, where the instructions are further executable by the one or more processors to output, for display via a user interface of the client device, a message that indicates a status of the execution of the data transaction at the second time after the first time, where the status includes at least one of a successful execution of the data transaction or a failure to execute the data transaction.

1. A client device comprising:
one or more processors; and
one or more memory configured to cause the one or more processors to:
receive, via an application associated with a payment service, a request to execute a data transaction;
detect a condition corresponding to a failure to execute the data transaction at a first time; and
execute, at a second time after the first time, the data transaction based on a change in the condition corresponding to the failure to execute the data transaction.

2. The client device of claim 1, wherein the one or more processors are further configured to output, for display via a user interface of the client device, a control that is selectable to cause execution of the data transaction based on a detection of the change in the condition corresponding to the failure to execute the data transaction.

3. The client device of claim 2, wherein the one or more processors are further configured to receive a selection via the control that indicates for the client device to execute the data transaction based on the detection of the change in the condition corresponding to the failure to execute the data transaction.

4. The client device of claim 1, wherein the one or more processors are further configured to output, for display via a user interface of the client device, a message that indicates a status of the execution of the data transaction at the second time after the first time, wherein the status comprises at least one of a successful execution of the data transaction or a failure to execute the data transaction.

5. The client device of claim 1, wherein the one or more processors are further configured to detect the change in the condition corresponding to the failure to execute the data transaction, and wherein detecting the change in the condition corresponding to the failure to execute the data transaction comprises at least one of:
detecting a change from a first network connection status to a second network connection status;
detecting a change from one or more first characteristics of a network connection to one or more second characteristics of the network connection;
detecting a change from a first server status to a second server status;
detecting a change in a value of a stored balance associated with the payment service, wherein the value of the stored balance satisfies a threshold value corresponds to a transaction value associated with the data transaction;
detecting a change in a threshold transaction value associated with the data transaction;
detecting expiry of a timer corresponding to a threshold numerical quantity of data transactions associated with the payment service;
detecting expiry of a timer corresponding to a threshold transaction value associated with the data transaction;
detecting a change to a geographic location corresponding to a greater threshold numerical quantity of data transactions associated with the payment service;
detecting a change to a geographic location corresponding to a greater threshold transaction value associated with the data transaction; or
detecting a change to at least one of a numerical quantity of data transactions associated with a geographic location or a threshold transaction value for one or more data transactions associated with the geographic location.

6. The client device of claim 1, wherein the one or more processors are further configured to receive, via an interactable element of a user interface displayed at the client device, user input indicating at least one of a threshold numerical quantity of data transactions associated with respective geographic locations of a plurality of geographic locations or a threshold transaction value associated with the respective geographic locations of the plurality of geographic locations.

7. The client device of claim 1, wherein the one or more processors are further configured to receive, via an interactable element of a user interface displayed at the client device, user input indicating an expiry time associated with executing the data transaction.

8. The client device of claim 7, wherein the one or more processors are further configured to execute the data transaction based on detecting the expiry time.

9. The client device of claim 1, wherein to receive the request to execute the data transaction, the one or more processors are configured to receive, via an interactable element of a user interface displayed at the client device, user input indicating the request to execute the data transaction.

10. The client device of claim 1, wherein the condition corresponding to the failure to execute the data transaction at the first time comprises at least one of a network connection status, one or more characteristics of a network connection, a server status, a value of a stored balance associated with the payment service, a threshold numerical quantity of data transactions associated with the payment service for a duration of a timer, a threshold numerical quantity of data transactions associated with a geographic location, or a threshold transaction value associated with the geographic location.

11. A method comprising:
receiving, at a client device and via an application associated with a payment service, a request to execute a data transaction;
detecting a condition corresponding to a failure to execute the data transaction at a first time; and
executing, at a second time after the first time, the data transaction based on a change in the condition corresponding to the failure to execute the data transaction.

12. The method of claim 11, further comprising outputting, for display via a user interface of the client device, a control that is selectable to cause execution of the data transaction based on a detection of the change in the condition corresponding to the failure to execute the data transaction.

13. The method of claim 11, further comprising outputting, for display via a user interface of the client device, a message that indicates a status of the execution of the data transaction at the second time after the first time, wherein the status comprises at least one of a successful execution of the data transaction or a failure to execute the data transaction.

14. The method of claim 11, further comprising detecting the change in the condition corresponding to the failure to execute the data transaction, wherein detecting the change in the condition corresponding to the failure to execute the data transaction comprises at least one of:
detecting a change from a first network connection status to a second network connection status;
detecting a change from one or more first characteristics of a network connection to one or more second characteristics of the network connection;
detecting a change from a first server status to a second server status;
detecting a change in a value of a stored balance associated with the payment service, wherein the value of the stored balance satisfies a threshold value corresponds to a transaction value associated with the data transaction;
detecting a change in a threshold transaction value associated with the data transaction;
detecting expiry of a timer corresponding to a threshold numerical quantity of data transactions associated with the payment service;
detecting expiry of a timer corresponding to a threshold transaction value associated with the data transaction;
detecting a change to a geographic location corresponding to a greater threshold numerical quantity of data transactions associated with the payment service;
detecting a change to a geographic location corresponding to a greater threshold transaction value associated with the data transaction; or
detecting a change to at least one of a numerical quantity of data transactions associated with a geographic location or a threshold transaction value for one or more data transactions associated with the geographic location.

15. The method of claim 11, further comprising receiving, via an interactable element of a user interface displayed at the client device, user input indicating an expiry time associated with executing the data transaction.

16. The method of claim 11, wherein receiving the request to execute the data transaction comprises receiving, via an interactable element of a user interface displayed at the client device, user input indicating the request to execute the data transaction.

17. The method of claim 11, wherein the condition corresponding to the failure to execute the data transaction at the first time comprises at least one of a network connection status, one or more characteristics of a network connection, a server status, a value of a stored balance associated with the payment service, a threshold numerical quantity of data transactions associated with the payment service for a duration of a timer, a threshold numerical quantity of data transactions associated with a geographic location, or a threshold transaction value associated with the geographic location.

18. A system comprising:
one or more processors; and
computer-readable storage media storing instructions that are executable by the one or more processors to:
receive, at a client device and via an application associated with a payment service, a request to execute a data transaction;
detect a condition corresponding to a failure to execute the data transaction at a first time; and
execute, at a second time after the first time, the data transaction based on a change in the condition corresponding to the failure to execute the data transaction.

19. The system of claim 18, wherein the instructions are further executable by the one or more processors to output, for display via a user interface of the client device, a control that is selectable to cause execution of the data transaction based on a detection of the change in the condition corresponding to the failure to execute the data transaction.

20. The system of claim 18, wherein the instructions are further executable by the one or more processors to output, for display via a user interface of the client device, a message that indicates a status of the execution of the data transaction at the second time after the first time, wherein the status comprises at least one of a successful execution of the data transaction or a failure to execute the data transaction.
